(19) United States
(12) Patent Application Publication
(10) Pub. No.: US 2026/0302492 A1
(43) Pub. Date: Oct. 1, 2026

(54) COUPLING STRUCTURE FOR SECONDARY BATTERY AND ELECTRONIC DEVICE INCLUDING COUPLING STRUCTURE

(71) Applicant: SAMSUNG SDI CO., LTD., Yongin-si (KR)

(72) Inventor: Kiyoun JEON, Yongin-si (KR)

(21) Appl. No.: 19/563,203

(22) Filed: Mar. 11, 2026

(30) Foreign Application Priority Data
Mar. 27, 2025 (KR) 10-2025-0039570

(51) Int. Cl. H01M 50/264; H01M 50/244

(52) U.S. Cl. CPC H01M 50/264; H01M 50/244

(57) ABSTRACT

The present disclosure relates to a coupling structure of a secondary battery including a first fixing part arranged to protrude from an outer side surface of a case of a secondary battery, and a second fixing part arranged to surround part of the outer side surface of the case and part of the at least one first fixing part.

### CROSS-REFERENCE TO RELATED APPLICATION

This application claims priority to and the benefit of Korean Patent Application No. 10-2025-0039570, filed on Mar. 27, 2025, in the Korean Intellectual Property Office, the entire disclosure of which is incorporated herein by reference.

### BACKGROUND

### Field

The present disclosure relates to a coupling structure for a secondary battery and an electronic device including the coupling structure.

### Description of Related Art

While primary batteries are not designed to be (re)charged, secondary (also known as rechargeable) batteries are batteries that are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

An additional fixing component, such as a screw tab, is typically coupled to a secondary battery to attach and detach a secondary battery to and from an electronic device. However, the use of the additional fixing component may lead to increased manufacturing costs, process complexity, or production times. In addition, the secondary battery may deform when a screw tab is coupled to a secondary battery.

Therefore, there is a demand for the coupling structure for a secondary battery to enhance the workability related to the fixing of the secondary battery. Also, there is a demand for component compatibility of the secondary battery and the electronic device including the secondary battery.

### SUMMARY

Embodiments of the present disclosure provide a coupling structure of a secondary battery and an electronic device including the coupling structure of the secondary battery.

Embodiments of the present disclosure provide a coupling structure of a secondary battery, including at least one first fixing part arranged to protrude from an outer side surface of a case of a secondary battery, and a second fixing part arranged to surround part of the outer side surface of the case and part of the at least one first fixing part.

Embodiments of the present disclosure provide a coupling structure of a secondary battery, including: at least one first fixing part configured to protrude from an outer side surface of a case of the secondary battery; and a second fixing part configured to surround part of the outer side surface of the case and part of the at least one first fixing part.

In some embodiments, the second fixing part is configured to be pre-installed in an electronic device where the secondary battery is to be mounted.

In some embodiments, the at least one first fixing part is capable of being screw-coupled.

In some embodiments, the coupling structure further includes a buffer material disposed between the at least one first fixing part and the second fixing part or between the case and the second fixing part.

In some embodiments, the at least one first fixing part is disposed at a bottom of a side of the case.

In some embodiments, a first of the at least one first fixing part is configured to protrude from a center of a first long side of the case, a second of the at least one first fixing part is configured to protrude from both edges of a second long side opposite to the first long side of the case, and the second fixing part is configured to surround the second of the at least one first fixing part and both edges of the second long side of the case.

In some embodiments, a first of the at least one first fixing part is configured to protrude from a first edge of the case, a second of the at least one first fixing part is configured to protrude from a second edge of the case diagonal to the first edge, and the second fixing part is configured to surround the second of the at least one first fixing part and the second edge of the case.

In some embodiments, a first of the at least one first fixing part is configured to protrude from a first edge of the case, a second of the at least one first fixing part is configured to be disposed from a second edge and a third edge of a second short side of the case opposite to a first short side including the first edge, and the second fixing part is configured to surround the second of the at least one first fixing part, the second edge, and the third edge.

In some embodiments, a first of the at least one first fixing part is configured to protrude from a center of a first long side of the case, a second of the at least one first fixing part is configured to protrude from a center of a second long side opposite to the first long side, and the second fixing part is configured to surround the second of the at least one first fixing part and the second long side.

In some embodiments, the at least one first fixing part is configured to protrude from a center of a first long side of the case, and the second fixing part is configured to surround a second long side opposite to the first long side of the case.

In some embodiments, a thickness of the buffer material is about 0.01 mm to about 0.5 mm.

Embodiments of the present disclosure provide a coupling structure of a secondary battery including at least one fixing part arranged to surround part of an outer side surface of a secondary battery, and a coupling means screw-joinable and arranged on the other side surface of the case.

Embodiments of the present disclosure provide a coupling structure of a secondary battery, including: at least one fixing part configured to surround part of an outer side surface of a case of the secondary battery; and a coupling means capable of being screw-coupled and disposed on an other outer side surface of the case.

In some embodiments, the fixing part is configured to be pre-installed in an electronic device where the secondary battery is to be mounted.

In some embodiments, the coupling structure further includes a buffer material disposed between the case and the at least one fixing part.

In some embodiments, the at least one fixing part is configured to surround both edges of a first long side of the case and part of an upper surface of the case, and the coupling means is configured to surround a center of a second long side opposite to the first long side of the case and the part of the upper surface of the case.

In some embodiments, a first of the at least one fixing part is configured to surround a first edge and part of an upper surface of the case, a second of the at least one fixing part is configured to surround a center of a second short side opposite to a first short side including the first edge and part of an upper surface, and the coupling means is configured to surround a center of a long side of the case including a second edge of the case diagonal to the first edge and the part of the upper surface of the case.

In some embodiments, a first of the at least one fixing part is configured to surround a center of a first long side of the case and part of an upper surface of the case, a second of the at least one fixing part is configured to surround a center of a first short side in contact with the first long side and the part of the upper surface of the case, a third of the at least one fixing part is configured to surround part of a second short side opposite to the first short side and the part of the upper surface of the case, and the coupling means is configured to surround a center of a second long side opposite to the first long side of the case and the part of the upper surface of the case.

In some embodiments, a thickness of the buffer material is about 0.01 mm to about 0.5 mm.

Embodiments of the present disclosure provide an electronic device including a coupling structure configured to couple a secondary battery to a specific position in the electronic device, the comping structure includes at least one first fixing part disposed to protrude from an outer side surface of a case of the secondary battery, and a second fixing part arranged to surround part of the outer side surface of the case and part of the first fixing part.

Embodiments of the present disclosure provide an electronic device, including: a coupling structure configured to couple a secondary battery to a specific position in the electronic device, wherein the coupling structure includes: at least one first fixing part configured to protrude from an outer side surface of a case of the secondary battery; and a second fixing part configured to surround part of the outer side surface of the case and part of the at least one first fixing part.

In some embodiments, the at least one first fixing part is capable of being screw-coupled.

According to some embodiments of the present disclosure, the use of an additional fixing component such as a screw tab conventionally used for attaching and detaching a secondary battery to and from an electronic device may be eliminated or minimized, thereby sufficiently reducing the manufacturing costs and the production times of an electrode device and stably fixing the secondary battery to the electronic device.

According to some embodiments of the present disclosure, structural deformations of a secondary battery, which may occur due to the use of an additional fixing component for fixing a secondary battery to an electronic device, may be minimized.

### BRIEF DESCRIPTION OF THE DRAWINGS

The drawings illustrate embodiments of the present disclosure and, together with the detailed description of the present disclosure, further describe aspects and features of the present disclosure. Accordingly, the present disclosure should not be construed as being limited to the drawings:

FIG. 1 is an exploded perspective view illustrating a secondary battery including a coupling structure of a secondary battery according to embodiments of the present disclosure;

FIG. 2A and FIG. 2B each illustrates a side view and a plan view of a coupling structure of a secondary battery according to embodiments of the present disclosure;

FIG. 3 illustrates a side view and a plan view of a coupling structure of a secondary battery according to embodiments of the present disclosure;

FIG. 4 illustrates a side view and a plan view of a coupling structure of a secondary battery according to embodiments of the present disclosure;

FIGS. 5A and 5B each illustrates a side view and a plan view of a coupling structure of a secondary battery according to embodiments of the present disclosure;

FIG. 6A and FIG. 6B each illustrates a side view and a plan view of a coupling structure of a secondary battery according to embodiments of the present disclosure;

FIG. 7 illustrates a side view and a plan view of a coupling structure of a secondary battery according to embodiments of the present disclosure;

FIG. 8 illustrates a side view and a plan view of a coupling structure of a secondary battery according to embodiments of the present disclosure; and

FIG. 9 illustrates a side view and a plan view of a coupling structure of a secondary battery according to embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the scope of the disclosure.

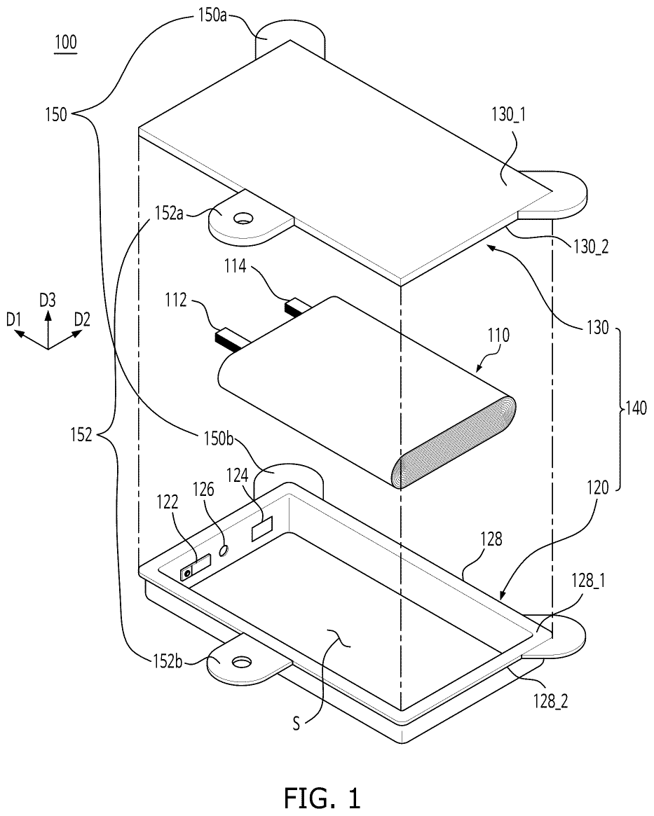

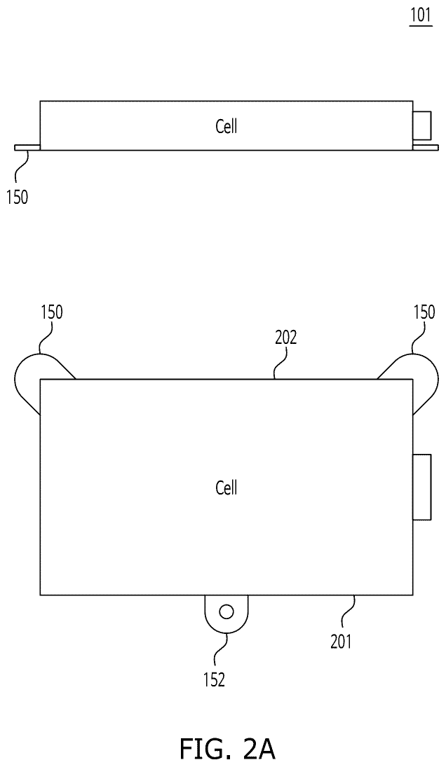

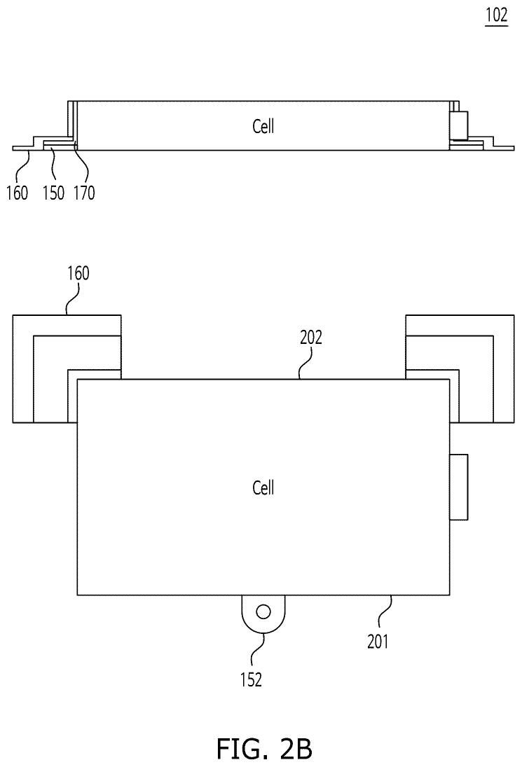

FIG. 1 is an exploded perspective view illustrating a secondary battery 100 including a coupling structure of a secondary battery according to embodiments of the present disclosure. FIG. 2A and FIG. 2B each illustrates a side view and a plan view of a coupling apparatus of a secondary battery according to embodiments of the present disclosure.

Referring to FIG. 1, FIG. 2A, and FIG. 2B, a secondary battery 100 having a coupling structure may comprise an electrode assembly 110 including a first electrode 111 in which a first electrode tab 112 is formed, a second electrode 113 in which a second electrode tab 114 is formed, and a separator 115 disposed between the first electrode 111 and the second electrode 113, and a case 140 configured to accommodate the electrode assembly 110. The case 140 may include a body 120 including an accommodating part S with one end open in a first direction D3 to accommodate the electrode assembly 110, and a flange part 128 extended from the open end toward a direction different from the first direction (D3) (e.g., D1 direction or D2 direction), and a cover 130 coupled to the flange part 128 for sealing one open end of the accommodating part S.

The electrode assembly 110 may be wound and stacked with a separator 115, which is an insulator, disposed between the first electrode 111 corresponding to a positive electrode and the second electrode 113 corresponding to a negative electrode. The secondary battery 100 shown in FIG. 1 may be a can-type secondary battery made of Stainless Use Steel (SUS). However, the present disclosure is not limited thereto, but may be any type of secondary battery such as a pouch type, a prismatic type, or a cylindrical type.

The positive electrode and the negative electrode may include a coated part in which an active material is coated on a current collector formed of a metal foil, and a non-coated part in which an active material is not coated. The positive electrode and the negative electrode may be wound with a separator, which is an insulator, disposed therebetween. However, the present disclosure is not limited thereto, but the electrode assembly may be formed by alternately stacking the positive electrode and the negative electrode formed of a plurality of sheets with a separator interposed therebetween.

A positive electrode may include a current collector and a positive electrode active material layer on the current collector. The positive electrode active material layer may include a positive electrode active material and may include a binder and/or a conductive material (e.g., an electrically conductive material).

For example, the positive electrode may include an additive that can serve as a sacrificial positive electrode.

An amount of the positive electrode active material may be about 90 wt % to about 99.5 wt % based on 100 wt % of the positive electrode active material layer. Amounts of the binder and the conductive material may each be about 0.5 wt % to about 5 wt % based on 100 wt % of the positive electrode active material layer.

The binder attaches the positive electrode active material particles one another and to attach the positive electrode active material to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, or nylon, as non-limiting examples.

The conductive material may be used to impart conductivity (e.g., electrical conductivity) to the electrode. Any material that does not cause a detrimental chemical change (e.g., does not cause an undesirable chemical change in the rechargeable lithium battery) while conducting electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, or silver, in a form of a metal powder or a metal fiber; a conductive polymer such as a polyphenylene derivative; or a mixture thereof.

Al may be used as the current collector, but is not limited thereto.

The separator may include polyethylene, polypropylene, polyvinylidene fluoride, or a multilayer film of two or more layers thereof, and a mixed multilayer film such as a polyethylene/polypropylene two-layer separator, a polyethylene/polypropylene/polyethylene three-layer separator, or a polypropylene/polyethylene/polypropylene three-layer separator.

The negative electrode may include a current collector and a negative electrode active material layer on the current collector. The negative electrode active material layer may include a negative electrode active material, and may include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may attach the negative electrode active material particles to one another and to attach the negative electrode active material to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may include a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, or a combination thereof.

When an aqueous binder is used as the negative electrode binder, a cellulose-based compound, capable of imparting viscosity, may be included. The cellulose-based compound may include carboxymethyl cellulose, hydroxypropylmethyl cellulose, methyl cellulose, or an alkali metal salt thereof. The alkali metal may include Na, K, or Li.

The dry binder may include a polymer material that is capable of being fibrous. For example, the dry binder may include polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause a detrimental chemical change (e.g., does not cause an undesirable chemical change in the rechargeable lithium battery) while conducting electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

The porous substrate may include a polymer film including polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON®, polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂ TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

Each of the first electrode tab 112 and the second electrode tab 114 may be connected to a non-coated part of the first electrode 111 and the second electrode 113 via welding, and may be formed by punching the non-coated part of the first electrode 111 and the second electrode 113. The first electrode tab 112 and the second electrode tab 114, in the wound state, may be arranged parallel to each other with a predetermined distance. The first electrode tab 112 and the second electrode tab 114 may be arranged on different surfaces and may be arranged in various other ways.

A case 140 may define the overall exterior of the secondary battery 100 and may include a metallic material such as stainless steel (e.g., Stainless Use Steel), aluminum, aluminum alloy, or nickel-plated steel. However, the case 140 may be formed of various metallic materials that satisfy the strength and resistance to external impact required for the secondary battery 100.

The case 140 may include a body 120 including an accommodating part S having one end opened in a direction (e.g., direction (D3)) perpendicular to an upper surface 128_1 of the flange part 128 to accommodate an electrode assembly 110 and the flange part 128 extended from the open end toward a direction (e.g., direction (D1) or direction (D2)) different from the direction (e.g., direction (D3)) perpendicular to the upper surface 128_1 of the flange part 128. The accommodating part S of the body 120 may be configured to include an internal space that accommodates the electrode assembly 110.

The planar geometry of the accommodating part S of the case 140 may have, for example, an approximate square geometry. The case 140 may include a cover 130 coupled to the flange part 128 to seal one open end of the accommodating part S. The cover 130 may include a flat plate arranged on the upper part of the case 140 to seal the accommodating part S. For example, the cover 130 may include a flat plate having a size to cover the flange part 128 to form a surface contact with the flange part 128. A lower surface 130_2 of the cover 130 and the upper surface 128_1 of the flange part 128 may be arranged to form a surface contact. The body 120 and the cover 130 may be formed of the same metal material. For example, the metal material may include contain stainless steel (e.g., SUS).

The flange part 128 may be bonded to the cover 130, so that the body 120 and the cover 130 may form an integrated structure. The body 120 may be bonded to the cover 130 by laser welding. However, the bonding method is not limited thereto, but various bonding methods may be used. For example, the cover 130 may be bonded to the flange part 128 by ultrasonic welding, brazing, laser brazing, welding, or soldering, in addition to laser welding.

A first electrode terminal 122, electrically connected to the first electrode tab 112 of the electrode assembly 110 and a second electrode terminal 124 electrically connected to the second electrode tab 114 of the electrode assembly 110, may be coupled to the body 120. For example, the first and second electrode terminals 122 and 124 may be arranged on at least one side of the case 140, specifically, on at least one side of the body 120. The locations of the first and second electrode terminals 122 and 124 are not limited to the locations shown in FIG. 1, and may vary.

The case 140 may include an electrolyte injection hole 126. For example, the electrolyte injection hole 126 may be a through hole formed on at least one side of the case 140. After the body 120 and the cover 130 are bonded and sealed, the electrolyte injection hole 126 may be formed for injecting an electrolyte into the inside of the case 140. The electrolyte injection hole 126 may be sealed by a sealing member after an electrolyte is injected.

The secondary battery 100 may be a lithium battery cell or a sodium battery cell. However, the present disclosure is not limited thereto, and the secondary battery 100 may include all batteries that may repeatedly provide electricity by charging and discharging. According to some embodiments, the secondary battery 100 is a lithium battery cell, and the secondary battery may be used in an electric vehicle (EV) with excellent life characteristics and high-rate characteristics. For example, the secondary battery may be used in a hybrid vehicle such as a plug-in hybrid electric vehicle (PHEV). In addition, the lithium battery cell may be used in fields that require a variety of power storage, for example, smartphones, tablet PCs, electric bicycles, or power tools, but the present disclosure is not limited thereto.

The coupling structure of the secondary battery 100 may include at least one of first fixing parts 150 and 152 arranged to protrude from the outer side of the case 140 of the secondary battery 100. At least one of the first fixing parts 150 and 152 may be coupled via screw-coupling. Screw coupling may be possible when a first fixing part 152 includes at least one through hole. For example, the first fixing part 152 including a through hole may be arranged at the center of the outer side of the cover 130 and at the center of the outer side of the flange part 128 to fix or bond the secondary battery 100 to an electronic device via screw-coupling. The through hole may have various geometries such as a circular geometry or a polygonal geometry. The through hole may be formed at the center of the first fixing part 152, but the location of the through hole is not limited thereto.

For example, a first fixing part 150 may be formed by coupling a first sub-fixing part 150a integral to the cover 130 and protruding from the outer side of the cover 130, to a first sub-fixing part 150b integral to the flange part 128 and protruding from the outer side of the flange part 128. The first fixing part 152 may be formed by coupling the first sub-fixing part 152a integral to and capable of being screw-coupled with the cover 130 to the first sub-fixing part 152b integral to and capable of being screw-coupled with the flange part 128. However, the coupling structure may have only the first sub-fixing part 150a and the first sub-fixing part 150b, or only the first sub-fixing part 152a and the first sub-fixing part 152b, but the present disclosure is not limited thereto.

The first fixing part 150 may be disposed at one end of the side surface of the case of the secondary battery, for example, at the lower end. However, the specific location where the first fixing part 150 protrudes from the outer side of the case 140 of the secondary battery 100 may be the minimum location necessary for the secondary battery 100 to be fixed to the electronic device eventually, but as long as the secondary battery 100 can be fixed to the electronic device, the present disclosure is not limited thereto.

The coupling structure of the secondary battery 100, as shown in FIG. 2B, may include a second fixing part 160 surrounding part of the outer side of the case and part of the first fixing part 150. For example, the second fixing part 160 may surround part of the outer side of the case 140 where the first fixing part 150 is disposed while covering the first fixing part 150.

The second fixing part 160 may be pre-installed in the electronic device in which the secondary battery 100 is to be mounted. For example, the secondary battery 100 may be fixed or coupled to the electronic device by inserting the first fixing part 150 into the second fixing part 160 pre-installed in the electronic device.

Referring to example 101 of FIG. 2A, one of the first fixing part 152, capable of being screw-coupled, may protrude from the center of a first long side 201 of the case, and the other of the first fixing part 150 may protrude from both edges of a second long side 202 opposite to the first long side 201 of the case.

Referring to example 102 of FIG. 2B, one of the first fixing part 152, capable of being screw-coupled, may protrude from the center of the first long side 201 of the case, the other of the first fixing part 150 may protrude from both edges of the second long side 202 opposite the first long side 201 of the case as shown in FIG. 2A, and the second fixing member 160 may surround the first fixing member 150 and both edges of the second long side 202 of the case. The coupling structure of the secondary battery may include a buffer material 170 disposed between the first fixing part 150 and the second fixing part 160 or between the case 140 of the secondary battery and the second fixing part 160. The buffer material 170, by damping any external impact, may reduce short-circuiting that may occur during charging-discharging of the secondary battery, thereby reducing the risks of defects and explosion. The thickness of the buffer material 170 may be from 0.01 mm to about 0.5 mm, preferably about 0.03 mm to about 0.4 mm, more preferably about 0.05 mm to about 0.2 mm.

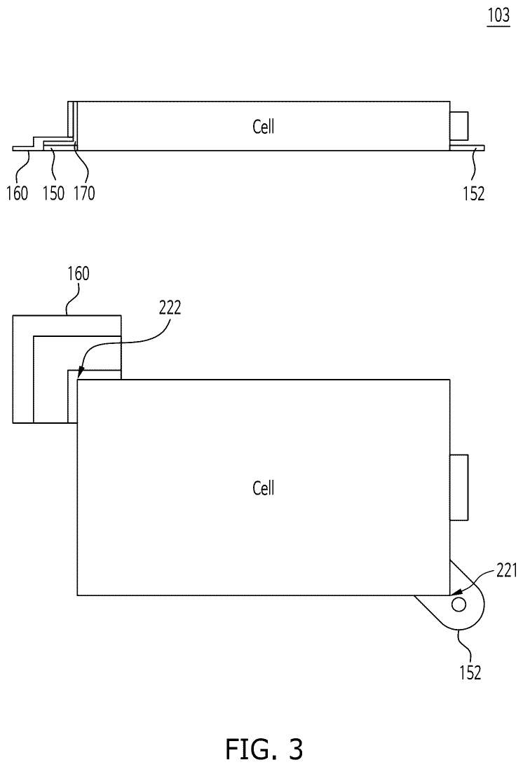

FIG. 3 illustrates a side view and a plan view of the coupling structure of a secondary battery 103 according to embodiments of the present disclosure. The secondary battery 103 shown in FIG. 3 may have the same or similar configuration as the secondary battery shown in FIG. 1, FIG. 2A, and FIG. 2B. The first fixing parts 150 and 152 of the secondary battery 103 shown in FIG. 3 may have the same or similar configuration as the first fixing parts 150 and 152 of the secondary battery shown in FIG. 1, FIG. 2A, and FIG. 2B.

Referring to FIG. 3, one of the first fixing part 152 may be capable of being screw-coupled and protrude from a first edge 221 of the case, and the other of the first fixing part 150 may protrude from a second edge 222 of the case, which is diagonal to the first edge 221. The second fixing part 160 may surround the second edge 222 of the case and the first fixing part 150 that protrudes from the second edge 222 of the case.

The buffer material 170 may be disposed between the first fixing part 150 and the second fixing part 160 or between the case of the secondary battery 103 and the second fixing part 160. The buffer material 170, by damping any external impact, may reduce short-circuiting that may occur during charging-discharging of the secondary battery, thereby reducing the risks of defects and explosion.

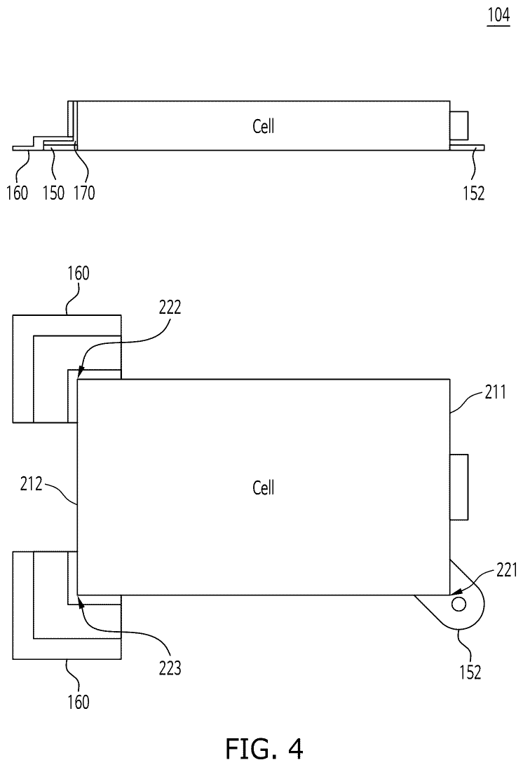

FIG. 4 illustrates a side view and a plan view of the coupling structure of a secondary battery 104 according to embodiments of the present disclosure. The secondary battery 104 shown in FIG. 4 may include the same or similar configuration as the secondary battery shown in FIG. 1, FIG. 2A, and FIG. 2B. The first fixing parts 150 and 152 of the secondary battery 104 shown in FIG. 4 may have the same or similar configuration as the first fixing parts 150 and 152 of the secondary battery shown in FIGS. 1, 2A, and 2B.

Referring to FIG. 4, one of the first fixing part 152 may be capable of being screw-coupled and protrude from the first edge 221 of the case, the other of the first fixing part 150 may protrude from the second edge 222 and a third edge 223 of a second short side 212 opposite to a first short side 211 including the first edge 221. The second fixing part 160 may surround the second edge 222 and the third edge 223 of the case, and the first fixing part 150 protrudes therefrom.

The buffer material 170 may be interposed between the first fixing part 150 and the second fixing part 160 or between the case of the secondary battery 104 and the second fixing part 160. The buffer material 170, by damping any external impact, may reduce short-circuiting that may occur during charging-discharging of the secondary battery, thereby reducing the risks of defects and explosion.

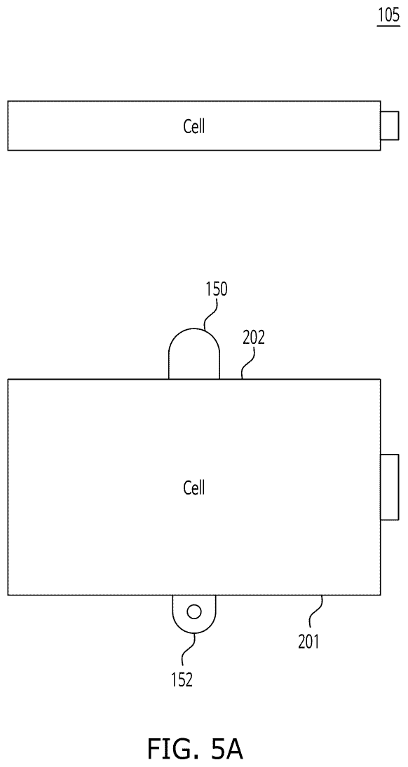

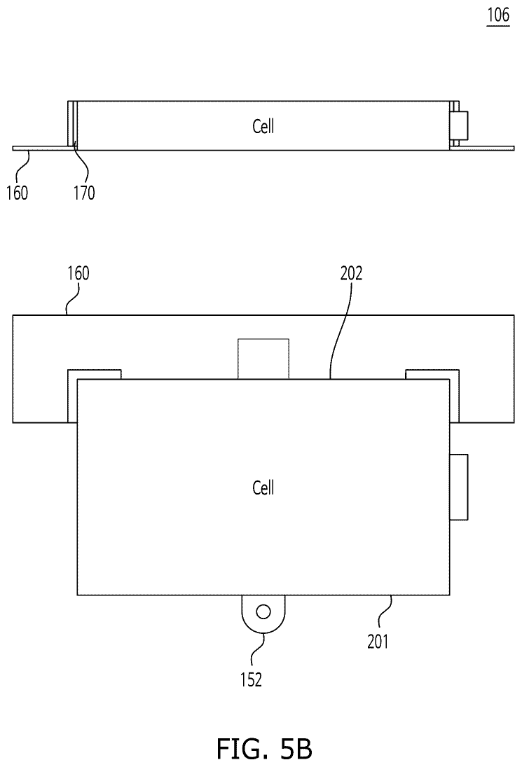

FIGS. 5A and 5B each illustrates a side view and a plan view of the first fixing parts 150 and 152 of the coupling structure of the secondary battery according to embodiments of the present disclosure. Secondary batteries 105 and 106 shown in FIGS. 5A and 5B, respectively, may have the same or similar configuration as the secondary battery shown in FIGS. 1, 2A, and 2B. In addition, the first fixing parts 150 and 152 of the secondary batteries 105 and 106, respectively, shown in FIGS. 5A and 5B, respectively, may have the same or similar configuration as the first fixing parts 150 and 152 of the secondary battery shown in FIGS. 1, 2A, and 2B.

Referring to FIGS. 5A and 5B, one of the first fixing part 152 may be capable of being screw-coupled and protrude from the center of a first long side 201 of the case, and the other of the first fixing part 150 may protrude from the center of the second long side 202 opposite to the first long side 201. The second fixing part 160 may surround the other of the first fixing part 150 protruding from the center of the second long side 202 opposite to the first long side 201 and the second long side 202. For example, after the secondary batteries 105 and 106 are placed so that the first fixing part 150 is coupled to the second fixing part 160 that is pre-installed, the secondary batteries 105 and 106 may be fixedly coupled to the electronic device by performing screw coupling to the first fixing part 152.

The buffer material 170 may be disposed between the first fixing part 150 and the second fixing part 160 or between the case of the secondary battery and the second fixing part 160. The buffer material 170, by damping any external impact, may reduce short-circuiting that may occur during charging-discharging of the secondary battery, thereby reducing the risks of defects and explosion.

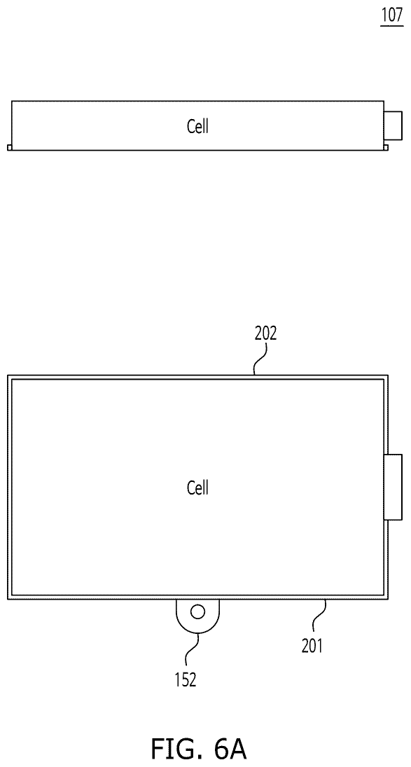

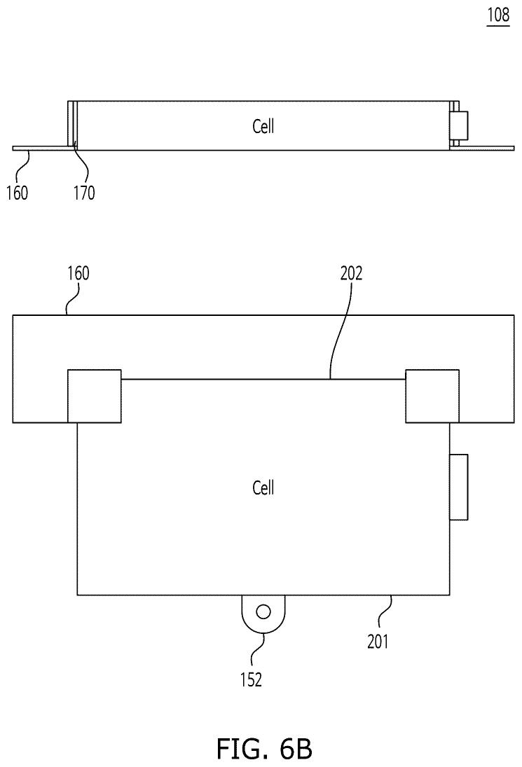

FIGS. 6A and 6B each illustrates a side view and a plan view of the coupling structure of the secondary battery according to embodiments of the present disclosure. Secondary batteries 107 and 108 shown in FIGS. 6A and 6B, respectively, may have the same or similar configuration as the secondary battery shown in FIGS. 1, 2A, and 2B. In addition, the first fixing part 152 of the secondary batteries 107 and 108 shown in FIGS. 6A and 6B, respectively, may have the same or similar configuration as the first fixing part 152 of the secondary battery shown in FIGS. 1, 2A, and 2B.

Referring to FIGS. 6A and 6B, the first fixing part 152 may be capable of being screw-coupled and protrude from the center of the first long side 201 of the case. In addition, the second fixing part 160 may surround the second long side 202 opposite to the first long side 201 of the case. For example, after the secondary batteries 107 and 108 are coupled to the second fixing part 160 that is pre-installed, the secondary batteries 107 and 108 may be fixedly coupled to the electronic device by performing screw coupling to the first fixing part 152.

The buffer material 170 may be interposed between the case of the secondary battery and the second fixing part 160. The buffer material 170, by damping any external impact, may reduce short-circuiting that may occur during charging-discharging of the secondary battery, thereby reducing the risks of defects and explosion.

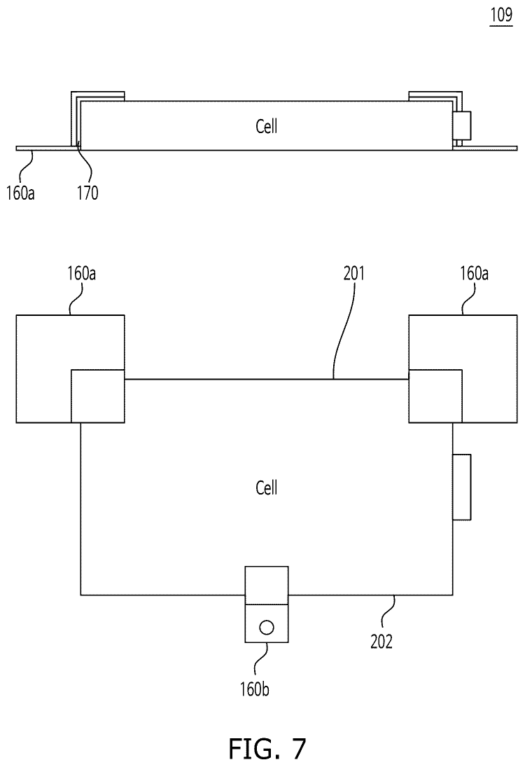

FIG. 7 illustrates a side view and a plan view of the coupling structure of a secondary battery 109 according to embodiments of the present disclosure.

Referring to FIG. 7, the coupling structure may include at least one fixing part 160a surrounding part of the outer side of the case and a coupling means 160b on the other outer side of the case and capable of being screw-coupled.

The fixing part 160a may be pre-installed in an electronic device in which the secondary battery is to be installed. For example, the secondary battery 109 may be fixed or coupled to the electronic device by inserting both edges of one side of the secondary battery 109 into the fixing part 160a that is pre-installed in the electronic device.

The coupling means 160b capable of being screw-coupled may include at least one through hole. For example, the coupling means 160b may be installed at the center of the other side of the case of the secondary battery 109 inserted into the fixing part 160a, and the secondary battery 109 may be fixedly coupled to the electronic device via screw-coupling.

The fixing part 160a may surround both edges of the first long side 201 of the case and part of the upper surface, and the coupling means 160b may surround the center of the second long side 202 opposite to the first long side 201 of the case and part of the upper surface of the case. For example, the fixing part 160a may be pre-installed in the electronic device, and the secondary battery 109 may be inserted into the fixing part 160a to surround both edges of the first long side 201 of the case and part of the upper surface of the case. After arranging the coupling means 160b to surround the center of the second long side 202 of the case and part of the upper surface of the case, the secondary battery 109 may be fixed to the electronic device via screw-coupling.

The buffer material 170 may be interposed between the case and the fixing part 160a. The buffer material 170 may be interposed between the case and the coupling means 160b. The buffer material 170, by damping any external impact, may reduce short-circuiting that may occur during charging-discharging of the secondary battery, thereby reducing the risks of defects and explosion.

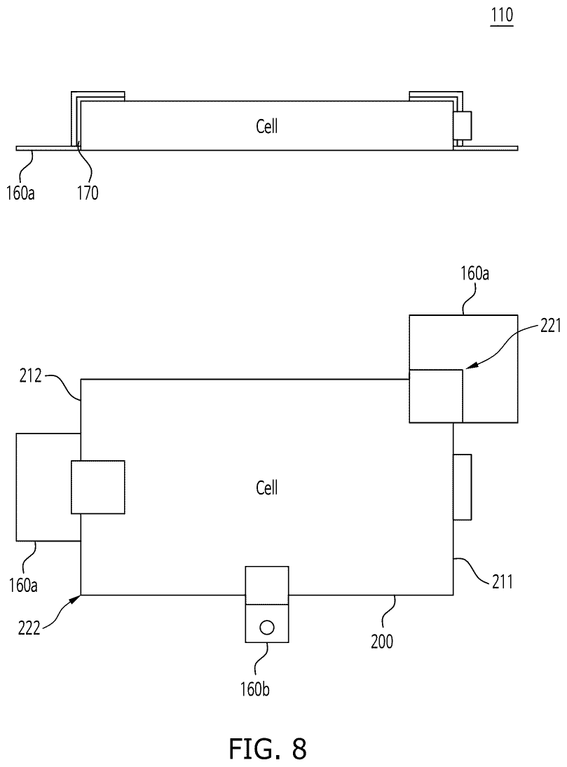

FIG. 8 illustrates a side view and a plan view of the coupling structure of a secondary battery 110 according to embodiments of the present disclosure. The secondary battery 110 illustrated in FIG. 8 may have the same or similar configuration as the secondary batteries illustrated in FIGS. 1, 2A, and 2B.

Referring to FIG. 8, one of the fixing part 160a may surround the first edge 221 and part of the upper surface of the case, the other of the fixing part 160a may surround the center of the second short side 212 opposite to the first short side 211 including the first edge 221 and part of the upper surface of the case, and a coupling means 160b, capable of being screw-coupled, may surround the center of a long side 200 of the case including a second edge 222 of the case disposed diagonally from the first edge 221 and part of the upper surface of the case.

The fixing part 160a may be pre-installed in the electronic device, and the secondary battery 110 may be inserted into the fixing part 160a so that one of the fixing part 160a may surround part of the first edge 221 and the upper surface of the case, and the other of the fixing part 160a may surround part of the center and the upper surface of the second short side 212. After the coupling means 160b is arranged to surround part of the center and the upper surface of the long side 200 of the case, the secondary battery 110 may be fixed to the electronic device via screw-coupling.

The buffer material 170 may be interposed between the case and the fixing part 160a. The buffer material 170 may be interposed between the case and the screw-coupled coupling means 160b. The buffer material 170, by damping any external impact, may reduce short-circuiting that may occur during charging-discharging of the secondary battery, thereby reducing the risks of defects and explosion.

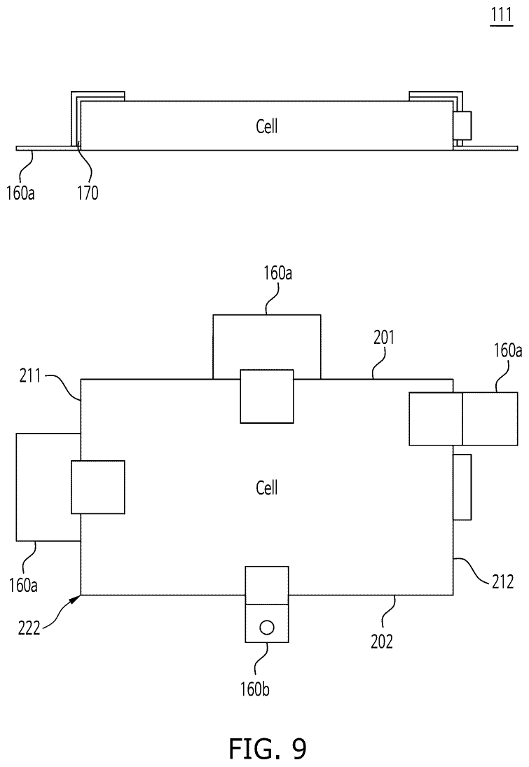

FIG. 9 illustrates a side view and a plan view of the coupling structure of a secondary battery 111 according to embodiments of the present disclosure. The secondary battery 111 shown in FIG. 9 may have the same or similar configuration as the secondary batteries shown in FIGS. 1, 2A, and 2B.

Referring to FIG. 9, one of the fixing part 160a may surround the center of the first long side 201 of the case of the secondary battery 111 and part of the upper surface of the case, a second one of the fixing part 160a may surround the center of the first short side 211 in contact with the first long side 201 and part of the upper surface, the third one of the fixing part 160a may be arranged to surround part of the second short side 212 opposite to the first short side 211 and part of the upper surface of the case, and the coupling means 160b, capable of being screw-coupled, may surround the center of the second long side 202 opposite to the first long side 201 of the case and part of the upper surface of the case.

The fixing part 160a may be pre-installed in the electronic device, and one of the fixing part 160a may surround the center of the first long side 201 of the case and part of the upper surface, the second one of the fixing part 160a may surround the center of the first short side 211 and part of the upper surface, and the third one of the fixing part 160a may surround part of the second short side 212 and part of the upper surface, so that the secondary battery 110 may be inserted into the fixing part 160a. The coupling means 160b may surround the center of the second long side 202 of the case and part of the upper surface of the case, and the secondary battery 111 may be fixed to the electronic device via screw-coupling.

The buffer material 170 may be interposed between the case and the fixing part 160a. The buffer material 170 may be interposed between the case and the screw-joinable coupling means 160b. The buffer material 170, by damping any external impact, may reduce short-circuiting that may occur during charging-discharging of the secondary battery, thereby reducing the risks of defects and explosion.

An electronic device according to embodiments of the present disclosure may include a coupling structure for coupling a secondary battery to a specific location of the electronic device, which includes at least one first fixing part arranged to protrude from an outer side surface of a case of the secondary battery, and a second fixing part arranged to surround part of the outer side surface of the case and part of the first fixing part.

In addition, the electronic device may include a coupling structure for coupling a secondary battery to a specific location of the electronic device, including at least one fixing part surrounding part of an outer side surface of a case of the secondary battery and a coupling means, capable of being screw-coupled, on the other outer side surface of the case.

The electronic device may have the secondary battery 100 as a partial or an entire power source. In some embodiments, the secondary battery 100 is used as a partial power source where AC power can be used as the main power source. In some embodiments, the device is portable driven only by the secondary battery 100. The electronic device may be any device in which the secondary battery 100 may be mounted. For example, the electronic device may include, but is not necessarily limited to, various small electronic devices including smartphones, mobile phones, PDAs, and laptop computers, or electric vehicles, plug-in hybrid vehicles, electric bicycles, and power tools.

Although the present disclosure has been described with respect to embodiments thereof, the present disclosure is not limited thereto. Various modifications and variations can be made thereto by those skilled in the art within the spirit of the present disclosure.

### DESCRIPTION OF REPRESENTATIVE REFERENCE NUMERALS

100: Secondary Battery
110: Electronic Assembly
111: First Electrode
112: First Electrode Tab
113: Second Electrode
114: Second Electrode Tab
115: Separator
120: Body
122: First Electrode Terminal
124: Second Electrode Terminal
126: Electrolyte Injection Hole
128: Flange Part
128_1: Upper Surface of Flange Part
128_2: Lower Surface of Flange Part
130: Cover
130_1: Upper Surface of Cover
130_2: Lower Surface of Cover
140: Case
150: First Fixing Part
160: Second Fixing Part
S: Accommodating Part

What is claimed is:

1. A coupling structure of a secondary battery, comprising:
at least one first fixing part configured to protrude from an outer side surface of a case of the secondary battery; and
a second fixing part configured to surround part of the outer side surface of the case and part of the at least one first fixing part.

2. The coupling structure as claimed in claim 1, wherein the second fixing part is configured to be pre-installed in an electronic device where the secondary battery is to be mounted.

3. The coupling structure as claimed in claim 1, wherein the at least one first fixing part is capable of being screw-coupled.

4. The coupling structure as claimed in claim 1, further comprising a buffer material disposed between the at least one first fixing part and the second fixing part or between the case and the second fixing part.

5. The coupling structure as claimed in claim 1, wherein the at least one first fixing part is disposed at a bottom of a side of the case.

6. The coupling structure as claimed in claim 3, wherein a first of the at least one first fixing part is configured to protrude from a center of a first long side of the case,
wherein a second of the at least one first fixing part is configured to protrude from both edges of a second long side opposite to the first long side of the case, and
wherein the second fixing part is configured to surround the second of the at least one first fixing part and both edges of the second long side of the case.

7. The coupling structure as claimed in claim 3, wherein a first of the at least one first fixing part is configured to protrude from a first edge of the case,
wherein a second of the at least one first fixing part is configured to protrude from a second edge of the case diagonal to the first edge, and
wherein the second fixing part is configured to surround the second of the at least one first fixing part and the second edge of the case.

8. The coupling structure as claimed in claim 3, wherein a first of the at least one first fixing part is configured to protrude from a first edge of the case,
wherein a second of the at least one first fixing part is configured to be disposed from a second edge and a third edge of a second short side of the case opposite to a first short side including the first edge, and
wherein the second fixing part is configured to surround the second of the at least one first fixing part, the second edge, and the third edge.

9. The coupling structure as claimed in claim 3, wherein a first of the at least one first fixing part is configured to protrude from a center of a first long side of the case,
wherein a second of the at least one first fixing part is configured to protrude from a center of a second long side opposite to the first long side, and
wherein the second fixing part is configured to surround the second of the at least one first fixing part and the second long side.

10. The coupling structure as claimed in claim 3, wherein the at least one first fixing part is configured to protrude from a center of a first long side of the case, and
wherein the second fixing part is configured to surround a second long side opposite to the first long side of the case.

11. The coupling structure as claimed in claim 1, wherein a thickness of the buffer material is about 0.01 mm to about 0.5 mm.

12. A coupling structure of a secondary battery, comprising:
at least one fixing part configured to surround part of an outer side surface of a case of the secondary battery; and
a coupling means capable of being screw-coupled and disposed on an other outer side surface of the case.

13. The coupling structure as claimed in claim 12, wherein the fixing part is configured to be pre-installed in an electronic device where the secondary battery is to be mounted.

14. The coupling structure as claimed in claim 12, further comprising a buffer material disposed between the case and the at least one fixing part.

15. The coupling structure as claimed in claim 12, wherein the at least one fixing part is configured to surround both edges of a first long side of the case and part of an upper surface of the case, and
wherein the coupling means is configured to surround a center of a second long side opposite to the first long side of the case and the part of the upper surface of the case.

16. The coupling structure as claimed in claim 12, wherein a first of the at least one fixing part is configured to surround a first edge and part of an upper surface of the case,
wherein a second of the at least one fixing part is configured to surround a center of a second short side opposite to a first short side including the first edge and part of an upper surface, and
wherein the coupling means is configured to surround a center of a long side of the case including a second edge of the case diagonal to the first edge and the part of the upper surface of the case.

17. The coupling structure as claimed in claim 12, wherein a first of the at least one fixing part is configured to surround a center of a first long side of the case and part of an upper surface of the case,
wherein a second of the at least one fixing part is configured to surround a center of a first short side in contact with the first long side and the part of the upper surface of the case,
wherein a third of the at least one fixing part is configured to surround part of a second short side opposite to the first short side and the part of the upper surface of the case, and
wherein the coupling means is configured to surround a center of a second long side opposite to the first long side of the case and the part of the upper surface of the case.

18. The coupling structure as claimed in claim 12, wherein a thickness of the buffer material is about 0.01 mm to about 0.5 mm.

19. An electronic device, comprising:
a coupling structure configured to couple a secondary battery to a specific position in the electronic device,
wherein the coupling structure comprises:
at least one first fixing part configured to protrude from an outer side surface of a case of the secondary battery; and
a second fixing part configured to surround part of the outer side surface of the case and part of the at least one first fixing part.

20. The electronic device as claimed in claim 19, wherein the at least one first fixing part is capable of being screw-coupled.
